(19) United States
(12) Patent Application Publication
(10) Pub. No.: US 2015/0195336 A1
(43) Pub. Date: Jul. 9, 2015

(54) DISTRIBUTION MECHANISM FOR ROUTER APPLICATIONS

(71) Applicant: QUALCOMM Incorporated, San Diego, CA (US)

(72) Inventors: Wayne Grosvenor Dunlap, Austin, TX (US); Michael William Cubbage, Austin, TX (US)

(73) Assignee: QUALCOMM Incorporated, San Diego, CA (US)

(21) Appl. No.: 14/151,557

(22) Filed: Jan. 9, 2014

(51) Int. Cl. H04L 29/08

(52) U.S. Cl. CPC H04L 67/06

(57) ABSTRACT

Systems, methods and computer program products download application packages to a mobile device from a traditional application store. The application package may include two applications, a first application executed on the mobile device (e.g., tablet computer, smartphone etc running an Android or iOS operating system) and a second application for execution on the router. When a user downloads and runs the first application on the mobile device, the first application determines if the router is present (e.g., determines if the mobile device is connected to the router) and if so, downloads the second application to the router. The second application may be the router application itself, or it may be an application that when executed on the router, downloads the router application to the router. Alternatively, the first application may issue a command that causes the router to download the router application.

### BACKGROUND

Embodiments of the inventive subject matter generally relate to the field of computers, and, more particularly, to distribution mechanisms for router applications.

As routers become more powerful, the ability to run third party networking applications is becoming more appealing. For example, applications such as parental control applications and virus scanning applications may be executed on a router. A router that is enhanced with such applications may be referred to as a “smart gateway” because it performs functions in addition to those traditionally performed by conventional routers. Applications for routers are typically obtained from the manufacturer or vendor of the router. For example, an application for a router may be obtained from an application store maintained by the router vendor. The proliferation of application stores can lead to confusion or other difficulties for a router owner that desires to obtain applications for their router.

### SUMMARY

Various embodiments are disclosed for implementing distribution mechanisms for router applications. In one embodiment, an application package is received by a device from a first application source. The application package includes a device application for execution on the device. Upon execution of the device application, the device application causes a router application to be downloaded to a router.

### BRIEF DESCRIPTION OF THE DRAWINGS

The present embodiments may be better understood, and numerous objects, features, and advantages made apparent to those skilled in the art by referencing the accompanying drawings.

FIG. 1 is a block diagram illustrating a system for providing an application to a router according to some embodiments.

FIGS. 2A-2C are block diagrams illustrating application packages according to some embodiments.

FIG. 3 is a flow diagram illustrating a method for providing an application to a router according to some embodiments.

FIGS. 4-6 are sequence diagrams illustrating sequences of operations for providing an application to a router according to some embodiments.

FIG. 7 is an example block diagram of one embodiment of an electronic device for implementing a router application distribution mechanism.

### DESCRIPTION OF EMBODIMENT(S)

The description that follows includes example systems, methods, techniques, instruction sequences and computer program products that embody techniques of the present inventive subject matter. However, it is understood that the described embodiments may be practiced without these specific details. For instance, although examples refer to mobile devices receiving application packages from an application store, other types of devices such as desktop or server computers may also receive application packages from an application store. In other instances, well-known instruction instances, protocols, structures and techniques have not been shown in detail in order not to obfuscate the description.

The embodiments include a distribution mechanism for router applications. An application package can be downloaded to a mobile device from a traditional application store. The application package may include two applications. A first application can be executed on the mobile device (e.g., tablet computer, smartphone, etc. running an Android™ or iOS operating system) and a second application can be a router application for execution on the router, where the router may run an operating system that is different from the mobile device. When a user downloads and runs the first application on the mobile device, the first application determines if the router is present (e.g., determines if the mobile device is connected to the router) and if so, downloads the second application to the router. The second application may be the router application itself, or it may be a small application that when executed on the router, downloads the router application to the router. Alternatively, the first application may issue a command that causes the router to download the router application.

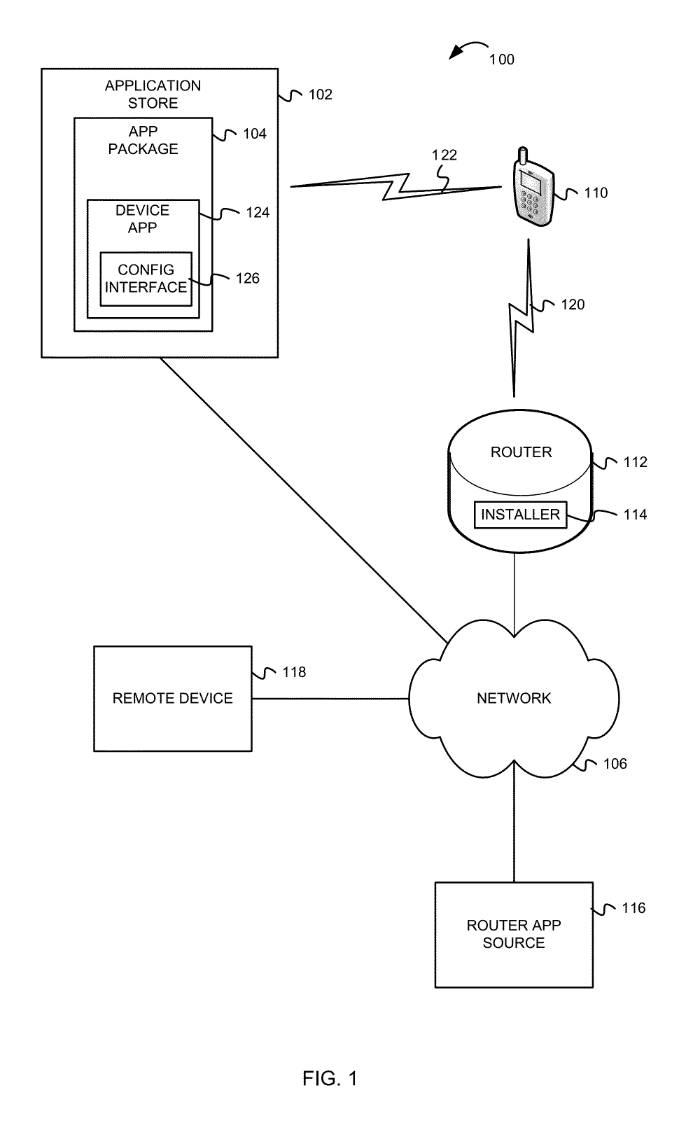

FIG. 1 is a block diagram illustrating a system 100 for providing an application to a router according to some embodiments. System 100 includes an application store 102, a router 112, and can include one or more of a mobile device 110, a remote device 118, or a router application source 116. Various network technologies may be used to communicably couple components of system 100. For example, router 112 may include either or both wired and wireless networking capabilities for communication over network 106 and with device 110. Examples of wireless networks include Wireless Local Area Network (WLAN), BLUETOOTH® (hereinafter “Bluetooth”), Worldwide Interoperability for Microwave Access (WiMAX), ZigBee®, etc. Examples of wired networks include Ethernet and powerline communication networks. The embodiments described herein are not limited to any particular wired or wireless network technology.

Mobile device 110 may be any type of mobile computing device. In some embodiments, device 110 may be a mobile phone such as a smartphone. In alternative embodiments, mobile device 110 may be a tablet or laptop computer. The embodiments are not limited to any particular type of mobile device.

Mobile device 110 may be configured to communicate with an application store 102. Application store 102 provides applications to mobile devices. In some embodiments, application store 102 may be a computer system configured to provide applications specific to a particular type of device or particular operating system that may be different from an operating system executing on router 112. For example, the Google® Play Store provides applications specific to devices (smartphones, tablet computers etc.) running the Android operating system. Similarly, the App Store® from Apple Computer, Inc. provides applications specific to the Apple® iPhone® series of smartphones and iPad® series of table computers that run the iOS operating system.

Mobile device 110 may communicate with application store 102 using any of the networking technologies available to the mobile device 110. For example, mobile device 110 may communicate to the application store via a wireless connection 120 established with router 112 (e.g., an IEEE 802.11 wireless connection). Alternatively, mobile device 110 may communicate with application store 102 via a 3G (Third Generation) or 4G LTE (Fourth Generation Long Term Evolution) connection 122 provided by a cellular communications service provider.

In some embodiments, mobile device 110 may provide a user interface for interacting with application store 102. The user interface can provide the ability for a user to select and download an application package 104 from application store 102. The application package can include a device application 124 for execution on mobile device 110. Device application 124, when executed, causes a router application to be downloaded to router 112. The router application may be a firewall application, a parental control application, or any other application executable on router 112. The router application may be included as part of application package 104. Alternatively, the router application may be downloaded from application store 102 separately from the download of application package 104 to mobile device 110. For example, the device application 124 may issue a command to router 112 instructing router 112 to obtain the router application from application store 102. Further, the router application may be downloaded to router 112 from a router application source 116. For example, router application source 116 may be a download site available through the Internet that is maintained by a manufacturer of router 112.

In some embodiments, installer 114 may receive a downloaded router application and install it on router 112. In alternative embodiments, installer 114 may receive a command from mobile device 110 that specifies a router application and instructs installer 114 to download and install the router application.

Router 112 may not have a user interface for configuring router applications. Device application 124 may include a configuration interface 126. Configuration interface 126 provides a user interface that can provide configuration parameters to a router application. For example, in the case of a firewall router application, configuration interface 126 may be used to provide rules and settings for the firewall router application. Similarly, in the case of a parental control router application, configuration interface 126 may be used to provide configuration parameters that are used by the parental control router application to filter content or determine whether access is provided to a network site through router 112.

In addition to mobile device 110, a remote device 118 may be used to provide applications to router 112 in a similar manner as described above with respect to mobile device 110. Remote device 118 may be any type of computer system, including a desktop computer, laptop computer, tablet computer, smartphone etc. Remote device 118 may also interface with application store 102 to download application packages that include a device application 124. The device application can execute on remote device 118 to cause a router application to be downloaded to router 112. Remote device can be used to access router 112 remotely, i.e., over a network such as the Internet. In some embodiments, remote device 118 may create a secure network tunnel to router 112 when downloading router applications to router 112 or when configuring router 112.

Further details on the operation of the above-described system will be provided below.

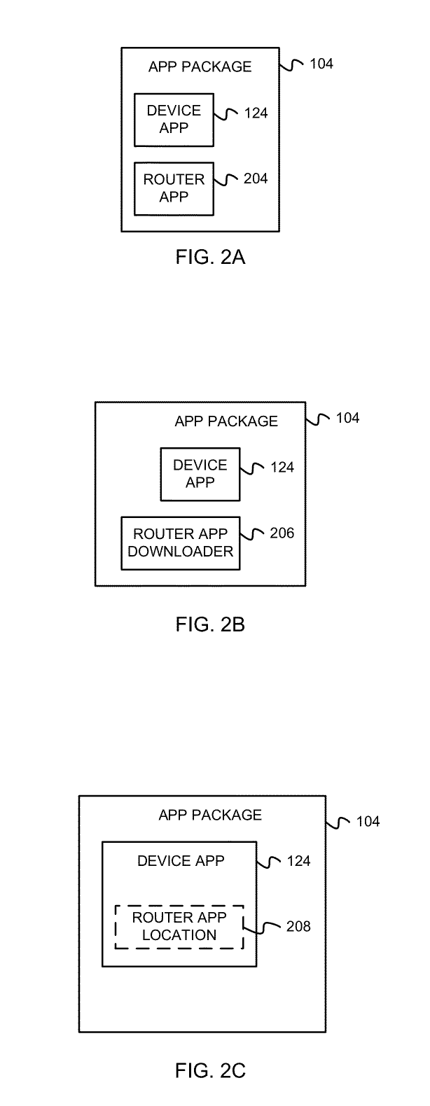

FIGS. 2A-2C are block diagrams illustrating application packages according to some embodiments. FIG. 2A illustrates an embodiment in which application package 104 includes both device application 124 and router application 204. In such embodiments, application package 104 may be downloaded to mobile device 110. When mobile device 110 executes device application 124, router application 204 may be extracted from application package 104 and downloaded to router 112. As discussed above, device application 124 may be designed to execute on an operating system for mobile device 110, while router application 204 may be designed to execute on an operating system for router 112 that may be different from the operating system executing on mobile device 110.

FIG. 2B illustrates an embodiment in which application package 104 includes device application 124 and a router application downloader 206. In such embodiments, application package 104 may be downloaded to mobile device 110. When mobile device 110 executes device application 124, router application downloader 206 may be extracted from application package 104 and downloaded to router 112. Router application downloader 206 may be an application that runs on router 112 to determine various router characteristics and uses the router characteristics to select and download an appropriate router application for the router. For example, router application downloader 206 may determine combinations of one or more of manufacturer, type and version information for router 112 so that a router application may be downloaded that is appropriate for the manufacturer, type and version of router 112. Other information from router 112 may be used to determine an appropriate router application. For example, operating system or hardware information for router 112 such as processor type may be used to determine an appropriate router application for router 112.

FIG. 2C illustrates an embodiment in which application package 104 includes device application 124. Device application 124 includes router application location data 208 that identifies a source for a router application. For example, router application location data 208 may include a Uniform Resource Locator (URL) that identifies a web site, server site, or other location where a router application is available. When mobile device 110 executes device application 124, router application location data 208 is communicated from device application 124 to router 112 informing router 112 to obtain the router application from the source indicated in router application location data 208. For example, device application 124 may communicate router application location data 208 to installer 114, which uses the location information to download and install the router application.

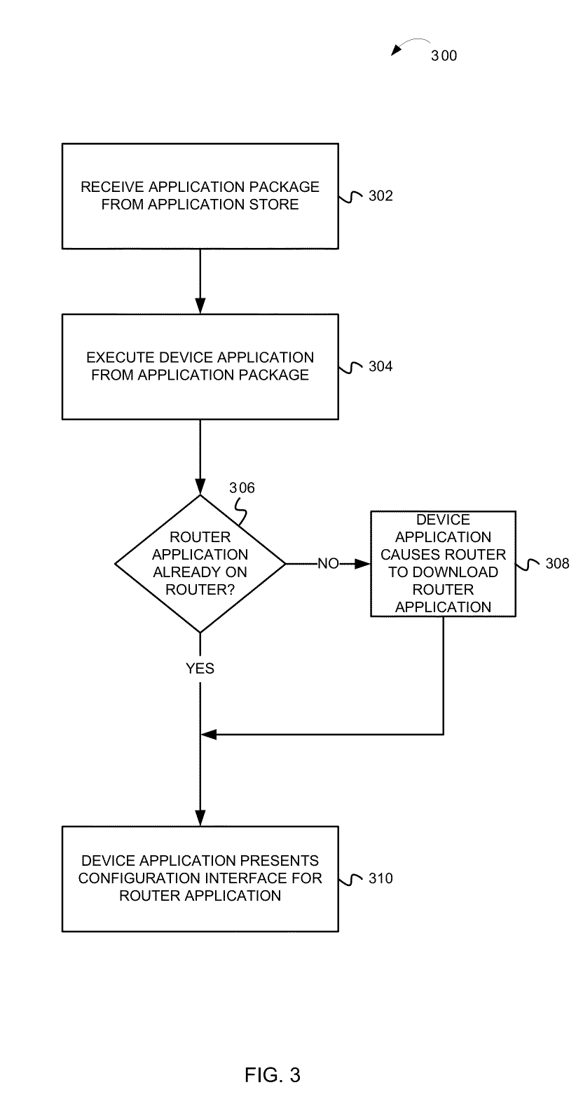

FIG. 3 is a flow diagram illustrating a method 300 for providing an application to a router according to some embodiments. Method 300 begins at block 302 with receiving an application package from an application store. As discussed above, the application package includes a device application for execution on a device such as mobile device 110. In some embodiments, the application package can be selected by a user based on a desired router application and a router type. In response to the selection, the application package is downloaded to the user's device.

At block 304, the device application is executed on the device.

At block 306, in some embodiments, the device application determines if the desired router application is already present on the router. The determination may include determining that the router application does not exist at all on the router. Alternatively, the determination may include determining that the router application is installed on the router, but the version of the currently installed router application is not the same as the version of the desired router application. For example, the version of a router application currently available for execution on a router may be an outdated version, and the desired version may be a most recent release of the router application.

At block 308, if the desired router application is not present on the router (or the desired version of the router application is not present), the device application causes the router application to be downloaded to the router. In some embodiments, the router application may be included in the same application package as the device application that was downloaded from the application store. In such embodiments, the device application may cause the router application to be extracted from the application package and downloaded to the router. In alternative embodiments, the device application may issue a command to the router directing the router to download the router application. The device application may supply a source for the router to use to obtain the router application.

In some embodiments, before a router application is downloaded or installed, the authenticity and authorization of the device executing the device application may be checked to determine if the device application is authorized to cause the router application to be downloaded and installed on the router. The authentication and authorization may be determined using wireless network security parameters. In such embodiments, the fact that the device is successfully connected to a secured wireless network is considered sufficient to determine the authenticity and authorization for the device to cause a router application to be downloaded to the router. In alternative embodiments, other mechanisms such as a user name and password combination or security certificates may be used to determine that a device application is authentic and authorized to cause router applications to be downloaded to a router.

At block 310, in some embodiments, the device application presents a configuration interface that may be used to supply configuration parameters for the newly installed router application. For example, a virus scanning router application may utilize configuration parameters that specify a level of scanning to be performed, or configuration parameters that specify file types, packet types etc. that are to be scanned. The configuration interface presented by the device application may be used to provide such configuration parameters for the router application.

In embodiments where the device application is executed on a remote device and may communicate with the router via public networks such as the Internet, a secure network tunnel may be established between the remote device and the router. The secure network tunnel provides a secure mechanism for downloading a router application to the router. Additionally, the secure network tunnel provides for secure transmission of configuration parameters and password so that a malicious user may be prevented from intercepting such information. Examples of secure network tunneling protocols include Virtual Private Network (VPN) and Secure Shell (SSH) tunneling protocols.

In addition to the security parameters that may be used to determine if the device application is authorized to download the router application to the router, the router application itself may include security mechanisms to restrict access to the router application. In some embodiments, the router application may restrict access to the application by requiring entry of a valid user name and password. In alternative embodiments, the router application may restrict access to the router application to the mobile device that caused the router application to be downloaded to the router. For example, the router application may store identification information for the device that caused the router application to be downloaded to the router. In some embodiments, the identification information may be a Media Access Control (MAC) address of the mobile device. The router may use the identification information to limit access to the router application to the mobile device. For example, the router may deny access to devices where the MAC address of the device seeking to access the router application does not match that of the mobile device that originally caused the router application to be downloaded to the router.

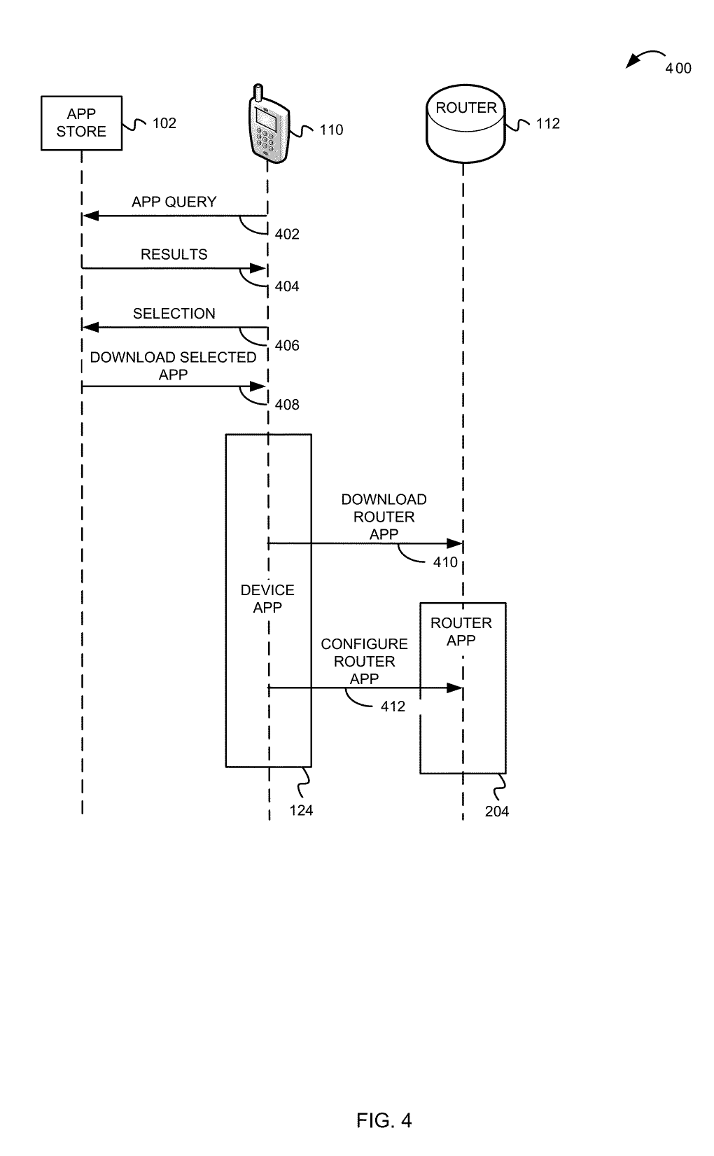

FIGS. 4-6 are sequence diagrams illustrating example sequences of operations for providing an application to a router according to embodiments. As will be appreciated by one of ordinary skill in the art having the benefit of the disclosure, the examples that follow are merely possible sequences of operations, and that variations and other sequences are possible and within the scope of the present disclosure.

FIG. 4 illustrates a sequence of operations 400 where an application package 104 received by a mobile device 110 from an application store 102 includes both a device application 124 and a router application 204. The example sequence of operations begins with operation 402, where mobile device 110 issues a query to application store 102 for a router application. In some embodiments, the query may include user provided parameters such as parameters describing the type of router application that the user desires. In some embodiments, a router type may also be included in the query to limit the query results to router applications that are compatible with the router type. The router type parameter may be provided by the user in some embodiments. In alternative embodiments, the mobile device 110 may query the router 112 for its router type, or may otherwise determine the router type from connection information available to mobile device 110.

At operation 404, the application store 102 returns results of the query from operation 402. The query result may comprise a list of applications that satisfy the query parameters received as part of the query.

At operation 406, mobile device 110 receives a selection of a router application from the applications in the query results provided at operation 404. For example, a user may provide a selection of an application via a user interface provided on mobile device 110 that displays the query results and provides a selection mechanism for selecting one or more of the query results.

At operation 408, in response to receiving the selection, application store 102 downloads to mobile device 110 an application package that corresponds to the selected router application. For the example illustrated in FIG. 4, the application package may be one such as described with reference to FIG. 2A that contains both a device application 124 and the selected router application 204.

Subsequent to completion of the download, a user may select device application 124 for execution on mobile device 110. In response to the user's selection, mobile device 110 can begin executing the device application. Device application 124 may detect that it is communicably coupled to router 112 (e.g., it is within range of router 112 and has established a network connection with router 112). At operation 410, device application 124 can download router application 204 to router 112. After router application 204 has been downloaded to router 112, router application 204 may be installed on router 112 and begin execution.

In some embodiments, at operation 412, device application 124 may present a user interface allowing a user to provide configuration parameters for router application 204. In alternative embodiments, configuration parameters may be retrieved and provided to router application 204 without user intervention. For example, device application 124 may receive configuration parameters from a configuration file included as part of application package 104. Alternatively, the configuration file may be read from mobile device 110 or from router 112.

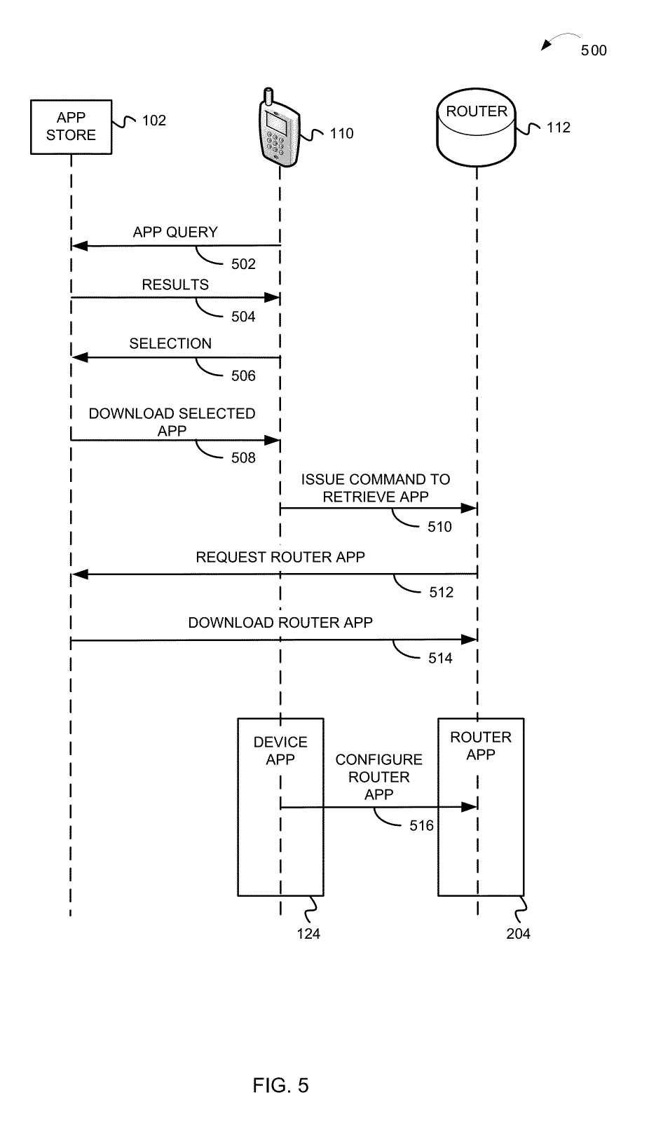

FIG. 5 illustrates a sequence of operations 500 where an application package 104 received by a mobile device 110 from an application store 102 includes a device application 124, but does not include a router application. Operations 502, 504, 506, and 508 are the same as operations 402, 404, 406, and 408 described above with reference to FIG. 4.

At operation 510, device application 124 issues a command to router 112 instructing router 112 to retrieve router application 204. The command may include parameters identifying the router application to be retrieved.

At operation 512, router 112 requests router application 204 from application store 102.

At operation 514, the requested router application 204 is downloaded from the application store 102 to router 112. After router application 204 has been downloaded to router 112, router application may be installed on router 112 and begin execution.

In some embodiments, at operation 516, device application 124 may present a user interface allowing a user to provide configuration parameters for router application 204. In alternative embodiments, configuration parameters may be retrieved and provided to the router application without user intervention. For example, device application 124 may receive configuration parameters from a configuration file included as part of application package 104. Alternatively, the configuration file may be read from mobile device 110 or from router 112.

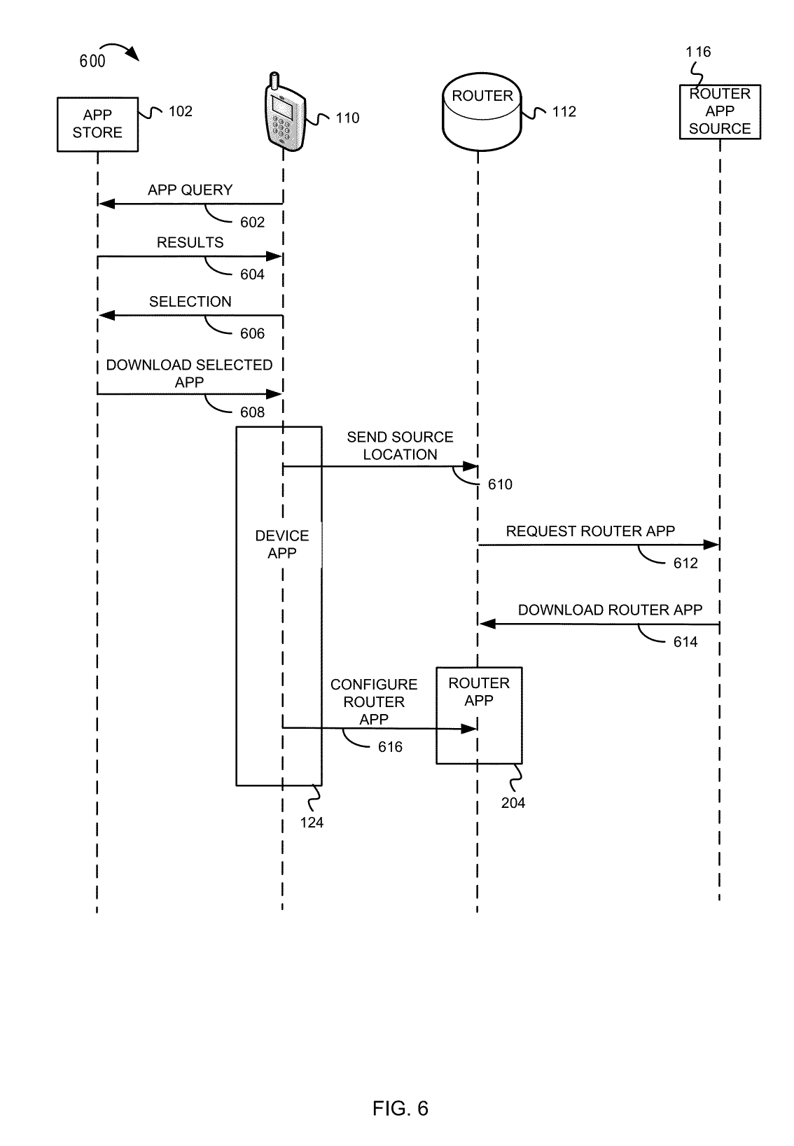

FIG. 6 illustrates a sequence of operations 600 where an application package 104 received by a mobile device 110 from an application store 102 includes a device application 124, and the device application 124 includes or has access to data identifying a source for router application 204. For purposes of the example illustrated in FIG. 6, the application package may be one such as described with reference to FIG. 2C. Operations 602, 604, 606, and 608 are the same as operations 402, 404, 406, and 408 described above with reference to FIG. 4.

At operation 610, device application sends information identifying a source for router application 204 to router 112. As noted above, the source location may be a URL identifying a web site or server that can provide router application 204 to router 112.

At operation 612, router 112 uses the source location information to identify the router application source 116 and issues a request for router application 204 to router application source 116.

At operation 614, router application source 116 downloads router application 204 to router 112. Router 112 may then install and begin execution of router application 204.

In some embodiments, at operation 616, device application 124 may present a user interface allowing a user to provide configuration parameters for router application 204. In alternative embodiments, configuration parameters may be retrieved and provided to the router application without user intervention. For example, device application 124 may receive configuration parameters from a configuration file included as part of application package 104. Alternatively, the configuration file may be read from mobile device 110 or from router 112.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

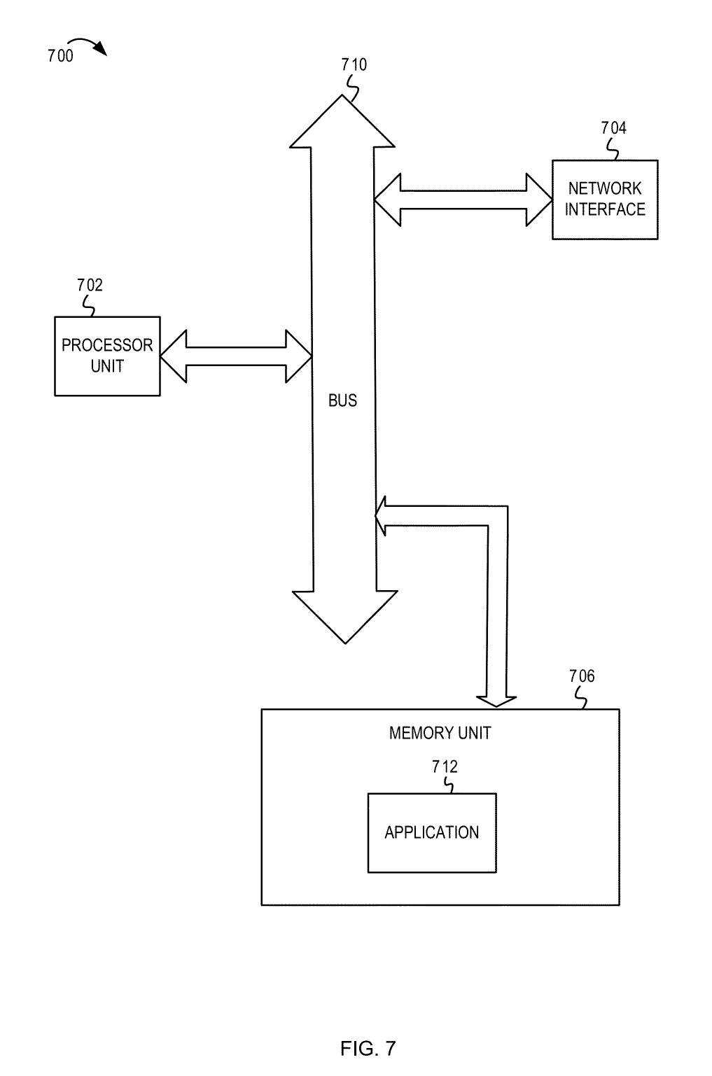

FIG. 7 is an example block diagram of one embodiment of an electronic device 700 including a router distribution mechanism in accordance with various embodiments of this disclosure. In some implementations, the electronic device 700 may be one of a laptop computer, a netbook, a mobile phone, a powerline communication device, a personal digital assistant (PDA), or other electronic systems. The electronic device 700 includes a processor unit 702 (possibly including multiple processors, multiple cores, multiple nodes, and/or implementing multi-threading, etc.). The electronic device 700 includes a memory unit 706. The memory unit 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 700 also includes a bus 710 (e.g., PCI, ISA, PCI-Express, HyperTransport®, InfiniBand®, NuBus, AHB, AXI, etc.), and network interface 704, that may be at least one of a wireless network interface (e.g., a WLAN interface, a Bluetooth® interface, a WiMAX interface, a ZigBee® interface, a Wireless USB interface, etc.) or a wired network interface. In one example embodiment the first network interface 704 may comprise a 2.4 GHz or 5 GHz wireless interface capable of utilizing IEEE 802.11a, 802.11b, 802.11g, 802.11n, or 802.11ac protocol. The electronic device 700 also includes application 712. Application 712 can be downloaded onto device 700 via network interface 704.

In implementations where device 700 is a mobile device or other computing device, application 712 may be a device application 124 that can be downloaded via network interface 704 and can be executed by processor unit 702. As described above in FIGS. 1-6, a device application may include functionality described above to download a router application to a router device. Additionally, electronic device 700 may include a display unit (not shown). The display unit may be used to provide a user interface for selecting application packages and for configuring a router application 204 through device application 124.

In implementations where device 700 is a router 112, application 712 may be a router application 204 that can be downloaded via network interface 704 for execution by processor unit 702. Further, device 700 may include installer 114 that can be executed by processor unit 702.

Further, realizations may include fewer or additional components not illustrated in FIG. 7 (e.g., video cards, audio cards, additional network interfaces, peripheral devices, etc.). The processor unit 702, the memory unit 706, and the network interface 704 are coupled to the bus 710. Although illustrated as being coupled to the bus 710, the memory unit 706 may be coupled to the processor unit 702.

While the embodiments are described with reference to various implementations and exploitations, it will be understood that these embodiments are illustrative and that the scope of the inventive subject matter is not limited to them. In general, techniques for providing a router application to a router as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method for providing an application to a router, the method comprising:
receiving, by a device, an application package from a first application source, the application package including a first application for execution on the device; and
executing, by the device, the first application;
wherein the first application causes a router application to be downloaded to the router.

2. The method of claim 1, wherein the first application is executable on a first operating system, and wherein the router application is executable on a second operating system different from the first operating system.

3. The method of claim 1, wherein the application package includes the router application, and further comprising downloading the router application to the router from the device.

4. The method of claim 1, wherein the application package includes a second application for execution on the router, and further comprising downloading the second application to the router from the device, wherein the second application, when executed on the router, downloads the router application to the router.

5. The method of claim 1, wherein the first application communicates location data specifying a source for the router application to the router, and wherein the router downloads the router application from the source.

6. The method of claim 1, further comprising:
determining a router type for the router; and
determining the router application based, at least in part, on the router type.

7. The method of claim 1, further comprising:
associating the device with the router application; and
limiting access to the router application to the device.

8. The method of claim 1, further comprising determining, by the first application, that the router application is not present on the router, wherein the first application causes the router application to be downloaded to the router in response to determining that the router application is not present on the router.

9. The method of claim 1, further comprising configuring the router application by the first application.

10. A method for providing an application to a router, the method comprising:
receiving a router application for execution on the router from a router application source, wherein reception of the router application is in response to a device receiving a first application from an application source and further in response to execution of the first application by the device; and
receiving, from the first application, configuration data for the router application.

11. The method of claim 10, wherein the router application is included in an application package, and further comprising receiving the router application from the device.

12. The method of claim 10, further comprising receiving a second application for execution on the router, wherein the second application downloads the router application to the router.

13. The method of claim 10, further comprising:
receiving, from the device, location data specifying a source for the router application; and
downloading, by the router, the router application from the source.

14. The method of claim 10, further comprising:
associating the device with the router application; and
limiting access to the router application to the device.

15. The method of claim 10, further comprising receiving configuration data for the router application from the device.

16. A method for providing an application to a router, the method comprising:
receiving by an application store, a request for an application package from a device, the application package including a first application for execution on the device; and
transmitting the application package to the device;
wherein the first application is configured to cause a router application to be downloaded to the router.

17. The method of claim 16, wherein the application package includes the router application, and wherein the first application is configured to download the router application to the router.

18. The method of claim 16, wherein the application package includes a second application for execution on the router, wherein the first application is configured to download the second application to the router, and wherein the second application downloads the router application to the router.

19. The method of claim 16, wherein the first application is configured to communicate location data specifying a source for the router application to the router.

20. The method of claim 16, wherein the first application is operable to present a user interface for providing configuration data for the router application.

21. An apparatus comprising:
a processor; and
a machine readable storage medium having machine usable program code embodied therewith, the machine usable program code executable by the processor to cause the apparatus to:
receive an application package from a first application source, the application package including a first application for execution on the apparatus; and
execute the first application, wherein the first application causes a router application to be downloaded to a router.

22. The apparatus of claim 21, wherein the first application is executable on a first operating system executed by the processor, and wherein the router application is executable on a second operating system different from the first operating system.

23. The apparatus of claim 21, wherein the application package includes the router application, and wherein the first application downloads the router application to the router.

24. The apparatus of claim 21, wherein the application package includes a second application for execution on the router, wherein the first application downloads the second application to the router, and wherein the second application, when executed on the router, downloads the router application to the router.

25. The apparatus of claim 21, wherein the first application communicates location data specifying a source for the router application to the router, and wherein the router downloads the router application from the source.

26. The apparatus of claim 21, wherein the machine usable program code further includes machine usable program code to cause the apparatus to:
determine a router type for the router; and
determine the router application based, at least in part, on the router type.

27. The apparatus of claim 21, wherein the first application includes a user interface to configure the router application.

28. A router comprising:
a processor; and
a machine readable storage medium having machine usable program code embodied therewith, the machine usable program code executable by the processor to cause the router to:
receive a router application from a router application source, wherein reception of the router application is in response to a device communicably coupled to the router receiving a first application from an application source and further in response to execution of the first application by the device; and
receive, from the first application, configuration data for the router application.

29. The router of claim 28, wherein the router application is included in an application package, and further comprising receiving the router application from the device.

30. The router of claim 28, wherein the machine usable program code further includes machine usable program code to cause the router to receive a second application, wherein the second application downloads the router application to the router.

31. The router of claim 28, wherein the machine usable program code further includes machine usable program code to cause the router to:
receive, from the device, location data specifying a source for the router application; and
download the router application from the source.

32. The router of claim 28, wherein the machine usable program code further includes machine usable program code to cause the router to:
associate the device with the router application; and
limit access to the router application to the device.

33. A machine-readable storage medium having stored thereon an application package, the application package including a device application and a router application, the device application comprising a first program product which, when executed by a first processor, causes the first processor to download the router application to a router.

34. The machine-readable storage medium of claim 33, wherein the device application is executable on a first operating system, and wherein the router application is executable on a second operating system different from the first operating system.

35. The machine-readable storage medium of claim 33, wherein the router application includes a second program product which, when executed by a second processor, causes the second processor to perform operations that comprise:
associating a device executing the device application with the router application; and
limiting access to the router application to the device.

36. One or more machine-readable media having stored therein a program product, which, when executed by a processor, causes the processor to perform operations that comprise:
receiving a router application for execution on a router from a router application source, wherein reception of the router application is in response to a device receiving a first application from an application source and further in response to execution of the first application by the device; and
receiving, from the first application, configuration data for the router application.

37. The one or more machine-readable media of claim 36, wherein the router application is included in an application package, and wherein the operations further comprise receiving the router application from the device.

38. The one or more machine-readable media of claim 36, wherein the operations further comprise:
receiving, from the device, location data specifying a source for the router application; and
downloading, by the router, the router application from the source.

39. The one or more machine-readable media of claim 36, wherein the operations further comprise:
associating the device with the router application; and
restricting access to the router application to the device.

40. The one or more machine-readable media of claim 36, wherein the operations further comprise receiving configuration data for the router application from the device.
